(19) United States
(12) Patent Application Publication
(10) Pub. No.: US 2012/0175387 A1
(43) Pub. Date: Jul. 12, 2012

(54) NOVEL EXTERNAL TAP ACTUATOR AND DISPENSE NOZZLE FOR COLLAPSIBLE LINER VALVES

(75) Inventors: Gregory Dixon Snell, Santa Rosa, CA (US); James Corbett Griffith, San Francisco, CA (US)

(73) Assignee: BETTER BARREL, INC., San Jose, CA (US)

(21) Appl. No.: 13/347,627

(22) Filed: Jan. 10, 2012

Related U.S. Application Data
(60) Provisional application No. 61/460,853, filed on Jan. 10, 2011.

(51) Int. Cl. B67D 7/06

(52) U.S. Cl. 222/505

(57) ABSTRACT

The invention provides an improved method for dispensing beverages from a collapsible liner fitted with a disposable valve. It comprises an external tap actuator with hand operated lever and integrated external dispense nozzle. The collapsible liner valve is located inside the housing of the external tap actuator. The external tap actuator's hand operated lever is configured in several ways to be compatible with three commercially available collapsible liner taps. When the hand operated lever opens the valve, the beverage flows into the said dispense nozzle which delivers the liquid to a beverage container such as a glass or carafe.

### CROSS-REFERENCE TO RELATED APPLICATIONS

This patent application is related to provisional patent application U.S. 61/460,853 filed Jan. 10, 2011 entitled A NOVEL EXTERNAL TAP ACTUATOR ASSEMBLY ATTACHED TO A RIGID ENCLOSURE HOUSING A COLLAPSIBLE LINER.

### SEQUENCE LISTING

### Patent References

US 2010/0133298 A1 APPARATUS COMPRISING A COOLING DEVICE FOR AT LEAST ONE BAG-IN-BOX PACKAGE
U.S. Pat. No. 6,003,742 SPIGOT ACTUATING DEVICE
U.S. Pat. No. 5,542,584 BOXED LIQUID VALVE OPERATOR
U.S. Pat. No. 5,797,524 SPIGOT ACTUATOR ASSEMBLY AND METHOD
U.S. Pat. No. 4,938,386 CUP TRIP ASSEMBLY
U.S. Pat. No. 5,012,017 MECHANICAL ACTUATOR FOR DISPENSING TAP
U.S. Pat. No. 5,402,919 LEVER DEVICE TO EASE VALVE OPERATION ON LIQUID BAG CONTAINERS
U.S. Pat. No. 3,313,516 SPRING BIASED VALVE OPERATING LEVER

### BACKGROUND OF THE INVENTION

### Technical Field

The present invention is related to the art of beverage dispensing and in particular dispensing from a collapsible liner with an external tap actuator.

The use of bag-in-the-box, or liquids housed in collapsible liners within a paper-board or corrugated paper box, for dispensing beverages has many advantages and remains a popular method of dispensing juice, wine, spirits, milk, tea and other non-carbonated beverages.

Normally, collapsible liners are filled with a beverage via an annular opening in the bag called a gland. When the bag is filled, a dispensing valve with a male annular fitting is inserted into female gland. The novel device described utilizes prior art from three commercially available collapsible liner valves. These dispensing valves are currently available in the marketplace from US based Scholle, Inc., France based Vitop a division of Smurfit-Kappa, Inc. and US based Rapak, Inc. These valves, to which the present invention is related, all require the user to apply force with one's fingers to actuate the valve. The valves are by design sized to fit inside the box during transport and to be cost effective. As a result of these requirements, the ease of operability is limited to that which can be fit inside the box and can be made to be cost effective.

Devices have been described in the prior art which claim to improve the operability of the collapsible liner valves. For example, in US patent in U.S. Pat. No. 4,905,875, issued to Straiton and U.S. Pat. No. 4,938,386, issued to Roethel, et al., they describe device which attached to a collapsible liner valve and actuates said valve caused by the movement of a container into a dispense receiving position below the tap body.

Other devices described in the prior art claim to improve the operability of the collapsible liner valves via a handle generally located above or in front of the said valve and provide mechanical advantage and can be operated with one hand without the need to pinch two surfaces to actuate the collapsible liner valve. For example, U.S. Pat. No. 3,313,516 issued to Peterson, U.S. Pat. No. 5,102,017 issued to Dirksing, U.S. Pat. No. 5,402,919 issued to Atkinson, U.S. Pat. No. 5,542,584 issued to Konar, U.S. Pat. No. 5,797,524 issued to Lentz, and U.S. Pat. No. 6,003,742 issued to Garcia, et al. describe levers attached to and located above or in front of the tap which can be operated with one hand and provide mechanical advantage.

All of the above referenced patents attach directly to the valve or gland assembly of the collapsible liner. There are problems with attaching a device directly to the tap and gland assembly of a collapsible liner. For example, it requires that it is removed each time the empty liner needs replacement and the device then needs to be attached to a filled liner. In addition to this problem, the above mentioned devices create an interference when a collapsible liner and its paperboard or cardboard housing is enclosed in a rigid enclosure for purposes of aesthetics, temperature control or to enhance the ability to position a receiving container below the dispense valve.

There are examples in the prior art of rigid enclosures designed to house collapsible liners and/or their cardboard housing. For example U.S. Pat. No. 3,696,969 issued to DeVan et al. describes a beverage dispensing system in the form of a decorative cask which houses a disposable beverage container with a collapsible liner. The said cask includes an aperture from which the said collapsible liner valve and gland protrude to the outside of the decorative cask to enable the valve to be operated and liquid to flow to a receiving receptacle outside the said cask. This design has problems. For example, due to the wall thickness of the cask and the length between the collapsible liner's gland to the valve dispense nozzle, there is very little space to position a receiving receptacle beneath it. The valve also requires a pinching action to actuate it.

Therefore it would be advantageous if there were a device which does not need to be attached to the valve or gland assembly which provides mechanical advantage, does not require a pinching force to actuate the valve and could provide additional outward directed flow to enable the improved positioning of a receiving receptacle under the dispenser outlet.

US Patent Application Publication US 2010/0133298 A1 describes a dispensing system which includes an external valve actuation device for a collapsible liner which is attached to the dispensing system and not to the valve or gland. However, this device does not direct the flow of the liquid after exit from the collapsible liner valve. As a result, the dispenser design requires that a receiving receptacle is positioned directly under the collapsible liner valve.

It is the goal of the present invention to improve the operability of current bag-in-box dispenser valves through the use of an external tap actuator with improved flow nozzle.

### BRIEF SUMMARY OF THE INVENTION

The present invention includes an external tap actuator body. This body receives and encloses a collapsible tap valve. It includes external tap lever sockets, an aperture allowing a hand operated lever to pass through the said body, a spring retaining member, and an external spout which directs flow outward from the collapsible tap outlet valve.

The external tap actuator includes a hand operated lever. This lever can be configured in three ways to be compatible with three commercially available collapsible liner taps without the need to modify the external tap actuator body.

The three commercially available collapsible liner valves require unique forces to actuate their internal valves: (1) A force, applied above and parallel to the collapsible liner valve dispense outlet flow, to a circular surface on a parallel plane to the tap gland and a force directed axially inward towards the collapsible liner. (2) A force, applied to a circular surface perpendicular to the dispense nozzle flow and on the opposite side of the tap outlet nozzle, where said nozzle is subjacent to said circular surface and the circular surface requires a force inward towards the tap nozzle to actuate the valve. (3) A lifting force, applied to two opposing levers which are on opposite sides of the valve body and perpendicular to the valve outlet flow and the tap outlet nozzle is subjacent to said opposing levers, where said levers require a lifting force away from the tap nozzle to actuate the valve.

The three hand operated levers all share the same handle and socket tube designs. They differ in the features located on the opposite end of the hand-operated lever and in one case the direction of pull by the user is away from the user in order to actuate the valve where in the two other cases the direction of pull is towards the user. They all share the same spring mechanism but vary in the location of the spring relative to the center of rotation of the lever.

### BRIEF DESCRIPTION OF THE DRAWINGS

FIG. 1 is a drawing representing prior art of three commercially available collapsible liner taps and glands assembled together. The uppermost tap is made by Vitop, a division of Smurfit-Kappa, the lower right tap is made by Scholle and the lower left tap is made by Rapak.

FIG. 2 is a perspective drawing of the external tap actuator body showing the external spout located subjacent to the body and the hand-operated lever located opposite the said spout.

FIG. 3 is a partial cut-away perspective of the present invention with the left side of the tap actuator body removed in order to show the position of the collapsible liner tap and gland within the body and the way in which the hand operated lever is inserted in the body's lever socket. In this drawing the Vitop valve and corresponding U-shaped lift hand operated lever is shown.

FIG. 4a is a full cut-away plan view drawing of the Scholle type valve within the external tap actuator body in the normally closed position. The design of the actuating mechanism of the hand-operated lever is shown.

FIG. 4b is the same cut-away plan view with the lever in the actuated position, allowing flow from the collapsible liner valve.

FIG. 5a is a full cut-away plan view drawing of the Rapak type valve within the external tap actuator body in the normally closed position. The design of the actuating mechanism of the hand-operated lever is shown.

FIG. 5b is the same cut-away plan view with the lever in the actuated position, allowing flow from the collapsible liner valve.

FIG. 6a is a full cut-away plan view drawing of the Vitop type valve within the external tap actuator body in the normally closed-position. The design of the actuating mechanism of the hand-operated lever is shown.

### DETAILED DESCRIPTION OF THE INVENTION

As briefly described this invention is related to the use of collapsible liners and valves in beverage dispensing. The present invention utilizes the prior art of three commercially available collapsible liner taps.

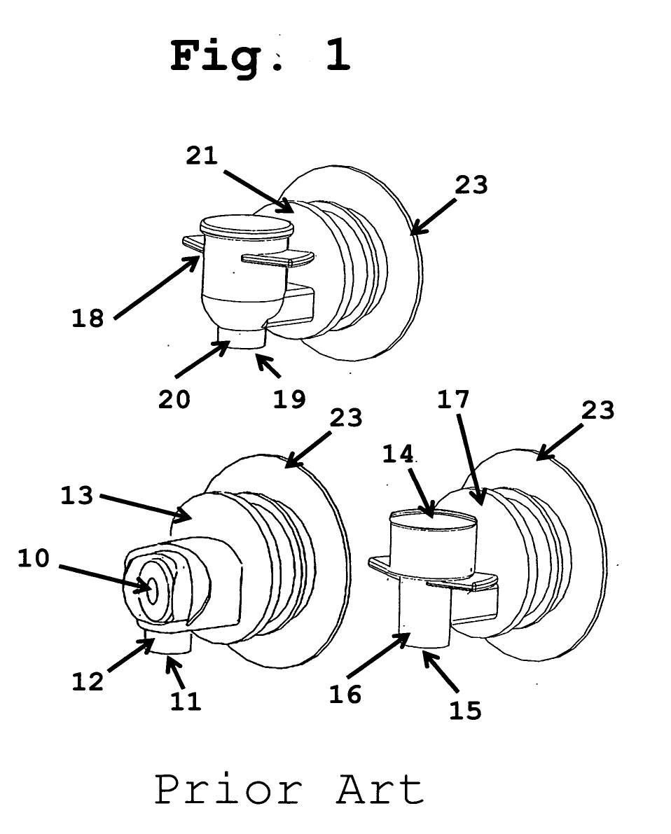

FIG. 1 includes the three taps. The uppermost tap is made by Vitop of France and it includes a 23 gland which is attached to the collapsible liner, a 21 circular male fitting which is inserted into the female gland. It also has a 19 outlet nozzle.

The said outlet nozzle has a 20 leading surface which is used to center and prevent over penetration of the tap into the external tap actuator. It also includes a mechanism to actuate the valve. This mechanism is comprised of 18 two opposing levers which are on opposite sides of the valve body and perpendicular to the valve outlet flow and the tap outlet nozzle. These levers are lifted away from the outlet nozzle in order to actuate the valve.

The lower left tap in FIG. 1 is made by Scholle of the US and it includes a 23 gland which is attached to the collapsible liner, a 13 circular male fitting which is inserted into the female gland. It also has an 11 outlet nozzle. The said outlet nozzle has a 12 leading surface which is used in the present invention to center and prevent over penetration of the tap into the external tap actuator. It also includes a mechanism to actuate the valve. This mechanism is comprised of 10 a circular button on a parallel plane to the tap gland. It actuates the valve when a force is directed axially inward towards the collapsible liner.

The lower right tap in FIG. 1 is made by Rapak of the US and it includes a 23 gland which is attached to the collapsible liner, a 17 circular make fitting which is inserted into the female gland. It also has a 15 outlet nozzle. The said outlet nozzle has a 16 leading edge surface which is used in the present invention to center and prevent over penetration of the tap into the external tap actuator. It also includes a mechanism to actuate the valve. This mechanism is comprised of a 15 circular button perpendicular to the dispense nozzle flow and on the opposite side of the tap outlet nozzle. When an inward force is applied to circular button the valve actuates.

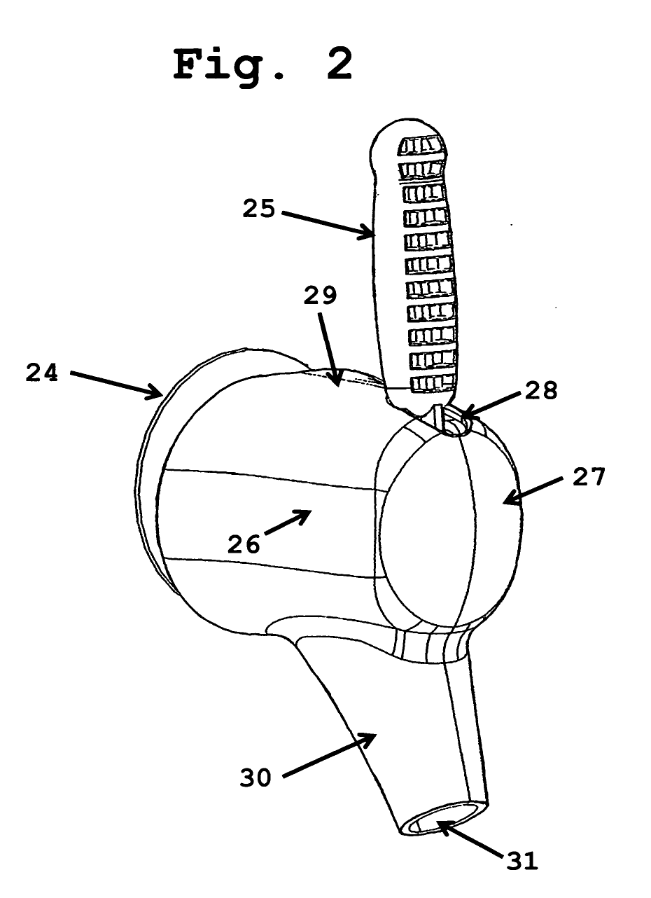

These three valves can be actuated externally by the present invention, an external valve actuator. The present invention is not mounted on the collapsible liner tap or gland. It can be located as part of a rigid enclosure or affixed thereto. The external tap actuator FIG. 2 has an 26 external body which houses the 24 collapsible liner tap and gland. The external body includes three apertures. The largest aperture 29 allows the entrance and exit of the 24 tap and gland. An aperture located on the top of the body, opposite an 30 external spout, allows the passage and pivoting of a 25 hand operated lever. The external spout is tubular in shape and generally slopes downward and away from the 24 tap and gland. The external spout has a 31 nozzle at the bottom which allows liquid to flow out from it.

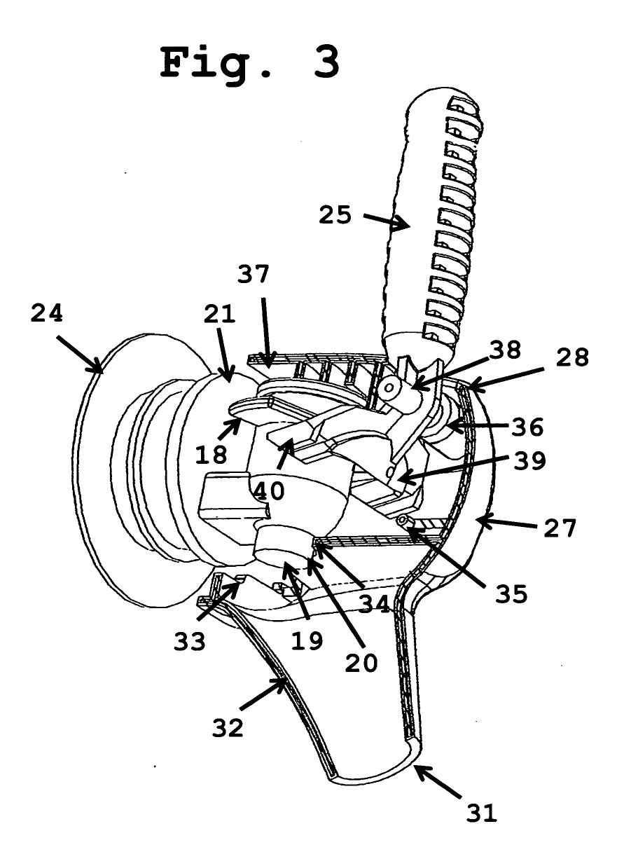

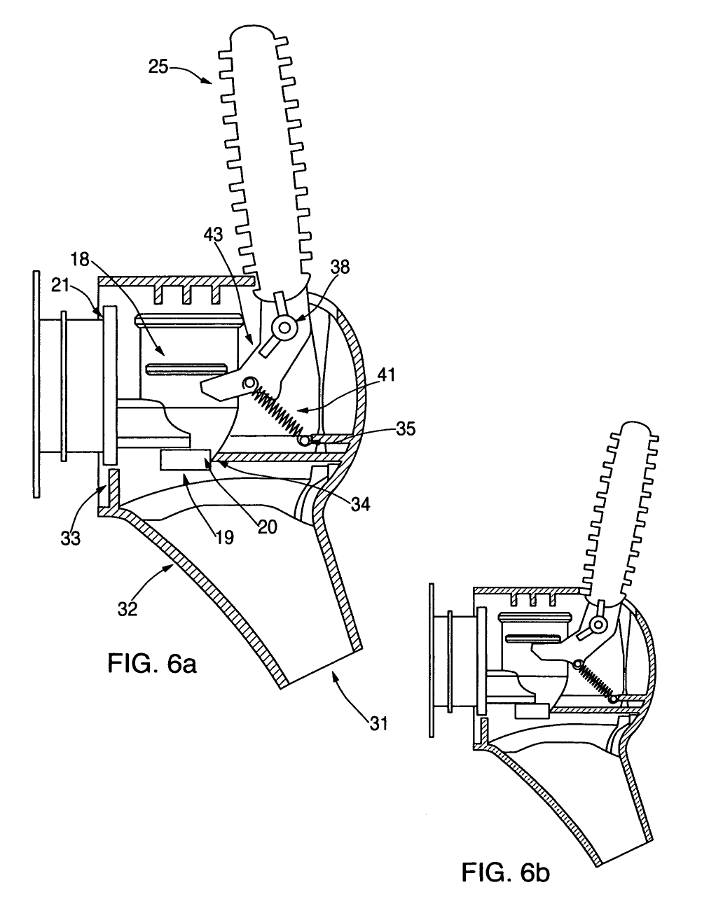

The internal design of the present invention enables it to cause the valve to flow without attaching to the tap or gland assembly through FIG. 3 the use of a 25 hand operated lever which is located in front of the tap and gland. The hand operated lever utilizes 38 socket tubes on opposing sides of the lever parallel to the 21 circular male fitting. These socket tubes rotate axially within 36 the external tap actuator lever sockets which are also located on either side of the socket tubes. The hand operated lever includes a 39 hole for affixing a FIG. 6a, 41 spring. Said spring's opposite end is attached to a 35 spring post which is parallel to the 21 circular male fitting and is further attached to the 27 external tap actuator body. The spring is normally in tension thereby pulling the hand operated lever towards the 35 spring post. This is important in order to not have an interference when the tap is inserted or removed from the cavity within the external tap actuator body.

The lever, in the case of the Vitop tap, utilizes 40 a U-shaped lift comprised of a semi-annular U shape. Equidistant to the tips of u shaped lift arms, the 25 hand operated lever intersects with and is attached to the hand operated lever on the opposite side of the 38 socket tube.

The tap is actuated when the user FIG. 6b pulls the handle forward causing the U-shaped lift to rise and to actuate the valve.

The tap is centered and placed in the proper distance within the external tap actuator through the use of a 34 nozzle centering plate. This plate centers the tap radially and axially in order to actuate the tap and direct the flow downward.

Below the tap is the 32 external spout. This spout bisects a 33 backflow dam, which prevents the flow of liquid outside of the spout, and directs the flow down and away from the tap 19 outlet nozzle. The bottom of the external spout ends in an 31 external spout nozzle.

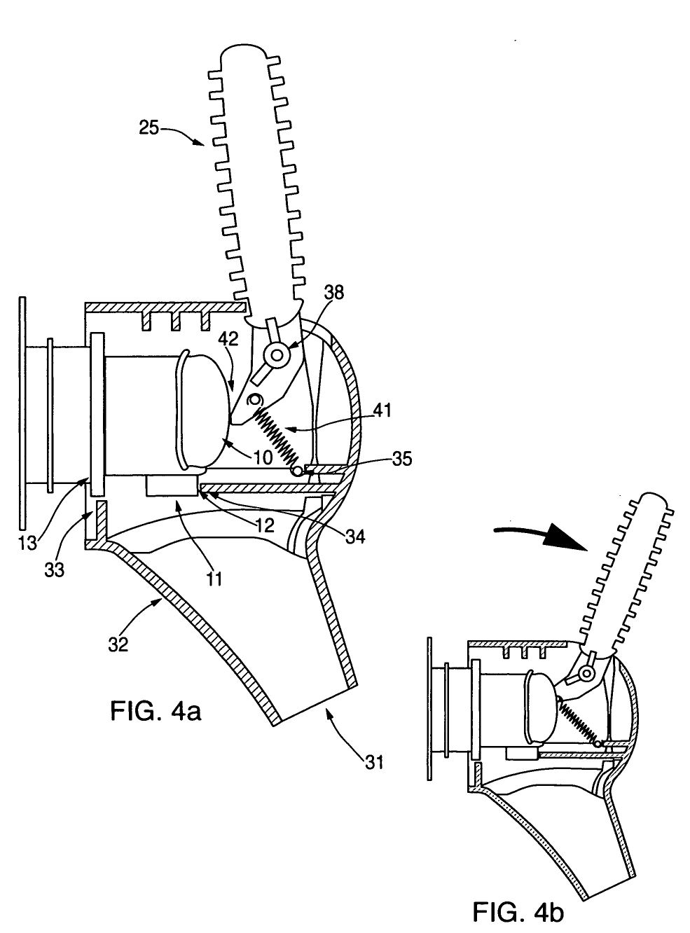

With a slight modification, shown in FIG. 4a, to the 42 inward thrusting arm and spring hole opposite end of the 25 hand operated lever, the same external tap body can be used to actuate a commercially available 13 tap by Scholle. The 42 inward thrusting arm is on a plane perpendicular the 38 socket tube and at an obtuse angle relative to the hand operated lever between 120 to 150 degrees towards the taps 10 circular button. When the tap is pulled forward, as shown in FIG. 4b, the valve actuates. Normally, the inward thrusting arm is pulled away from the tap through the use of a 41 spring under tension.

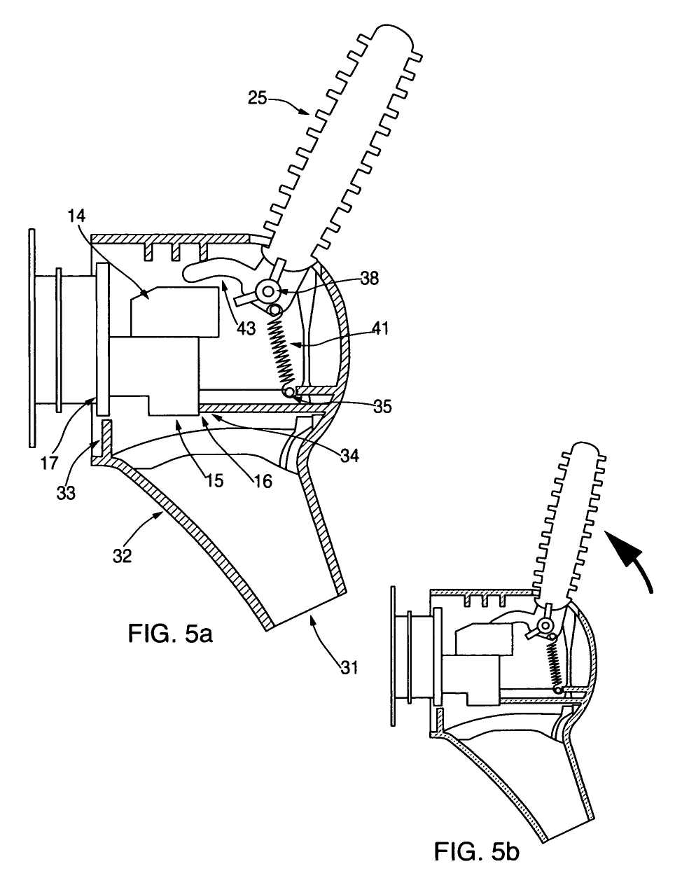

Another modification to the actuating mechanism of the hand operated lever can be done to allow the actuation of a Rapak valve as shown in FIG. 5a. This modification to the arm creates a downward thrusting force. The 43 downward thrusting arm is on a plane perpendicular the 38 socket tube and at an acute angle relative to the hand operated lever becoming semi annular in the direction of the tap. When the tap is pushed backward, as shown in FIG. 5b, the valve actuates. Normally, the downward thrusting arm is pulled upward and away from the tap through the use of a 41 spring under tension.

In the above description, numerous details have been set forth in order to provide a more thorough understanding of the present invention. It will be obvious, however, to anybody skilled in the art that the present invention may be practiced without these specific details. In other instances, well known features have not been described in detail in order to not obscure unnecessarily the present invention.

The invention claimed is:

1. For use with a container containing a potable liquid and having a collapsible liner including an annular gland into which a cylindrical tap is installed, said tap having an internal valve restricting flow to an outlet nozzle and an external valve actuating mechanism which requires the force of upward lifting of opposing levers located on said tap body to actuate the valve, with an external tap actuator attached to a rigid surface, the surface of which is not the tap or gland, and the rigid surface is parallel to the annular gland inlet and the external tap actuator is composed of a hand-operated lever with said lever comprising a hand lever, socket tubes and a U-shaped lift, and is attached to said external tap actuator through opposing sockets, with the lever utilizing the said U-shaped lift to create a lifting force on the said opposing levers to actuate the valve, and said external tap actuator comprising an external spout located below the collapsible liner tap outlet nozzle which re-directs the flow of liquid to an external spout outlet nozzle which is not directly adjacent to the collapsible liner tap outlet.

2. For use with a container containing a potable liquid and having a collapsible liner including an annular gland into which a cylindrical tap is installed, said tap having an internal valve restricting flow to an outlet nozzle and an external valve actuating mechanism which requires the force of inward pressing of a button located parallel to the outlet flow of said collapsible tap body to actuate the valve, with an external tap actuator attached to a rigid surface, the surface of which is not the tap or gland, and the rigid surface is parallel to the annular gland inlet and the external tap actuator is composed of a hand-operated lever with said lever comprising a hand lever, socket tubes and an inward thrusting arm at an oblique angle to the hand operated lever handle, and is attached to said external tap actuator through opposing sockets, with the lever utilizing the said inward thrusting arm to create an inward force on the said button to actuate the valve, and said external tap actuator comprising an external spout located below the collapsible liner tap outlet nozzle which re-directs the flow of liquid to an external spout outlet nozzle which is not directly adjacent to the collapsible liner tap outlet.

3. For use with a container containing a potable liquid and having a collapsible liner including an annular gland into which a cylindrical tap is installed, said tap having an internal valve restricting flow to an outlet nozzle and an external valve actuating mechanism which requires the force of inward pressing of a button located above and perpendicular to the outlet flow of said collapsible tap body to actuate the valve, with an external tap actuator attached to a rigid surface, the surface of which is not the tap or gland, and the rigid surface is parallel to the annular gland inlet and the external tap actuator is composed of a hand-operated lever with said lever comprising a hand lever, socket tubes and a downward thrusting arm starting at an obtuse angle to the hand operated lever handle and becoming semi-annular in the direction of the tap, and is attached to said external tap actuator through opposing sockets, with the lever utilizing the said downward thrusting arm to create an inward force on the said button to actuate the valve, and said external tap actuator comprising an external spout located below the collapsible liner tap outlet nozzle which re-directs the flow of liquid to an external tap spout outlet nozzle which is not directly adjacent to the collapsible liner tap outlet.
